(19) United States
(12) Patent Application Publication
(10) Pub. No.: US 2026/0329256 A1
(43) Pub. Date: Oct. 22, 2026

(54) Sequence-Aware Inline Measurement Attribution Method

(71) Applicant: International Business Machines Corporation, Armonk, NY (US)

(72) Inventors: Tsuyoshi Ide, Harrison, NY (US); Kohei Miyaguchi, Tokyo (JP)

(21) Appl. No.: 19/185,500

(22) Filed: Apr. 22, 2025

(51) Int. Cl. G05B 19/4099

(52) U.S. Cl. CPC G05B 19/4099; G05B 2219/45031

(57) ABSTRACT

Predictive modeling for a semiconductor manufacturing procedure is provided. A lot-sharing count matrix is defined that represents manufacturing operations shared between wafers within the same lot up to a point of measurement. A similarity matrix is defined with the lot-sharing count matrix. A value function is defined for a set of sequential process trajectories that include a specified measurement item in the sequence, wherein missing variables in the trajectories are imputed by a lot-aware kernel imputation (LAKI) algorithm using a weighted average based on the similarity matrix. Based on the value function, a weighting function is calculated that averages over the set of sequential process trajectories. A trajectory Shapley value attribution score is calculated for the measurement item based on value function and weighting function. The semiconductor manufacturing procedure is adjusted according to changes in advanced process control parameters based on the trajectory Shapley value score.

### BACKGROUND

The disclosure relates generally to manufacturing and more specifically to attributing defects to steps withing sequential manufacturing processes.

Root cause analysis (RCA) of wafer quality issues is a central task in semiconductor process integration. Cross-process RCA is particularly challenging due to the sequential and combinatorial nature of processing routes, where heterogeneous physical processes are performed by numerous processing tools across different wafer-lot-batch hierarchies.

RCA is often approached as a by-product of virtual metrology (VM) modeling, which aims to predict a quality metric as a function of process variables. Typically, VM is formulated as a regression or classification problem. However, existing approaches still face challenges that hinder their practicality. Regularized linear regression combined with variable selection techniques, a commonly adopted VM approach, essentially performs variable-wise correlation analysis for attribution, disregarding the sequential nature of the processing route. While recurrent neural networks (RNNs) and Transformers can capture complex nonlinear dependencies in sequential processes, they operate as black boxes, making input attribution a non-trivial task.

### SUMMARY

An illustrative embodiment provides a computer-implemented method of predictive modeling for a semiconductor manufacturing procedure. The method comprises defining a lot-sharing count matrix that represents a number of manufacturing operations shared between semiconductor wafers within the same lot up to a point of measurement and defining a similarity matrix with the lot-sharing count matrix. A value function is defined for a set of sequential process trajectories that include a specified measurement item in the sequence, wherein missing variables in the trajectories are imputed by a lot-aware kernel imputation (LAKI) algorithm using a weighted average based on the similarity matrix. Based on the value function, a weighting function is calculated that averages over the set of sequential process trajectories. A trajectory Shapley value attribution score is calculated for the measurement item based on value function and weighting function. The semiconductor manufacturing procedure is then adjusted according to changes in advanced process control (APC) parameters based on the trajectory Shapley value score. According to other illustrative embodiments, a computer system and a computer program product for predictive modeling for a semiconductor manufacturing procedure are provided.

### BRIEF DESCRIPTION OF THE DRAWINGS

FIG. 1 is a block diagram of a computing environment in accordance with an illustrative embodiment;

FIG. 2 is a diagram illustrating defect attribution in accordance with an illustrative embodiment;

FIG. 3 depicts a table summarizing a dataset collected from semiconductor fabrication;

FIG. 4 depicts a graph illustrating results of univariate correlation;

FIG. 5A depicts a graph illustrating Trajectory Shapley Attribution scoring for a bad semiconductor wafer in accordance with an illustrative embodiment;

FIG. 5B depicts a graph illustrating Trajectory Shapley Attribution scoring for a good semiconductor wafer in accordance with an illustrative embodiment; and

FIG. 6 depicts a flowchart illustrating a method of predictive modeling for a semiconductor manufacturing procedure in accordance with an illustrative embodiment.

### DETAILED DESCRIPTION

A computer-implemented method performed predictive modeling for a semiconductor manufacturing procedure. The method comprises defining a lot-sharing count matrix that represents a number of manufacturing operations shared between semiconductor wafers within the same lot up to a point of measurement and defining a similarity matrix with the lot-sharing count matrix. A value function is defined for a set of sequential process trajectories that include a specified measurement item in the sequence, wherein missing variables in the trajectories are imputed by a lot-aware kernel imputation (LAKI) algorithm using a weighted average based on the similarity matrix. Based on the value function, a weighting function is calculated that averages over the set of sequential process trajectories. A trajectory Shapley value attribution score is calculated for the measurement item based on value function and weighting function. The semiconductor manufacturing procedure is then adjusted according to changes in advanced process control (APC) parameters based on the trajectory Shapley value score. As a result, the illustrative embodiments provide a technical effect of adjusting semiconductor manufacturing according to a trajectory Shapley value score.

The similarity matrix is based on the Jaccard index. As a result, the illustrative embodiments provide a technical effect of basing the similarity matrix on the Jaccard index.

Each element of the similarity matrix lies within the unit interval [0, 1]. As a result, the illustrative embodiments provide a technical effect of keeping the elements of the similarity matrix within the unit interval [0, 1].

The trajectory Shapley value attribution score is calculated with a trained classifier model that determines a probability of a semiconductor wafer being defective. As a result, the illustrative embodiments provide a technical effect of determining whether a semiconductor wafer is defective.

The probability of a semiconductor wafer being defective comprises a binary target variable wherein a value of 1 indicates the presence of a specified defect type and a value of 0 indicates otherwise. As a result, the illustrative embodiments provide a technical effect of expressing the presence of a defect as a binary value.

The trajectory Shapley value attribution score quantifies the contribution of the measurement item to the probability of a semiconductor wafer being defective. As a result, the illustrative embodiments provide a technical effect of attributing responsibility for a defect to a measurement item within a sequence of processes.

The set of sequential process trajectories include trajectories that progress sequentially from a first process without skipping intermediate steps. As a result, the illustrative embodiments provide a technical effect of limiting analysis to uninterrupted sequences of manufacturing processes.

A computer system comprises a storage device that stores program instructions and one or more processors operably connected to the storage device and configured to execute the program instructions to cause the system to define a lot-sharing count matrix that represents a number of manufacturing operations shared between semiconductor wafers within the same lot up to a point of measurement; define a similarity matrix with the lot-sharing count matrix; define a value function for a set of sequential process trajectories that include a specified measurement item in the sequence, wherein missing variables in the trajectories are imputed by a lot-aware kernel imputation (LAKI) algorithm using a weighted average based on the similarity matrix; calculate, based on the value function, a weighting function that averages over the set of sequential process trajectories; calculate a trajectory Shapley value attribution score for the measurement item based on value function and weighting function; and adjust the semiconductor manufacturing procedure according to changes in advanced process control (APC) parameters based on the trajectory Shapley value score. As a result, the illustrative embodiments provide a technical effect of adjusting semiconductor manufacturing according to a trajectory Shapley value score.

The similarity matrix is based on the Jaccard index. As a result, the illustrative embodiments provide a technical effect of basing the similarity matrix on the Jaccard index.

Each element of the similarity matrix lies within the unit interval [0, 1]. As a result, the illustrative embodiments provide a technical effect of keeping the elements of the similarity matrix within the unit interval [0, 1].

The trajectory Shapley value attribution score is calculated with a trained classifier model that determines a probability of a semiconductor wafer being defective. As a result, the illustrative embodiments provide a technical effect of determining whether a semiconductor wafer is defective.

The probability of a semiconductor wafer being defective comprises a binary target variable wherein a value of 1 indicates the presence of a specified defect type and a value of 0 indicates otherwise. As a result, the illustrative embodiments provide a technical effect of expressing the presence of a defect as a binary value.

The trajectory Shapley value attribution score quantifies the contribution of the measurement item to the probability of a semiconductor wafer being defective. As a result, the illustrative embodiments provide a technical effect of attributing responsibility for a defect to a measurement item within a sequence of processes.

The set of sequential process trajectories include trajectories that progress sequentially from a first process without skipping intermediate steps. As a result, the illustrative embodiments provide a technical effect of limiting analysis to uninterrupted sequences of manufacturing processes.

A computer program product performs predictive modeling for a semiconductor manufacturing procedure. A persistent storage medium has program instructions configured to cause one or more processors to define a lot-sharing count matrix that represents a number of manufacturing operations shared between semiconductor wafers within the same lot up to a point of measurement; define a similarity matrix with the lot-sharing count matrix; define a value function for a set of sequential process trajectories that include a specified measurement item in the sequence, wherein missing variables in the trajectories are imputed by a lot-aware kernel imputation (LAKI) algorithm using a weighted average based on the similarity matrix; calculate, based on the value function, a weighting function that averages over the set of sequential process trajectories; calculate a trajectory Shapley value attribution score for the measurement item based on value function and weighting function; and adjust the semiconductor manufacturing procedure according to changes in advanced process control (APC) parameters based on the trajectory Shapley value score. As a result, the illustrative embodiments provide a technical effect of adjusting semiconductor manufacturing according to a trajectory Shapley value score.

The similarity matrix is based on the Jaccard index. As a result, the illustrative embodiments provide a technical effect of basing the similarity matrix on the Jaccard index.

Each element of the similarity matrix lies within the unit interval [0, 1]. As a result, the illustrative embodiments provide a technical effect of keeping the elements of the similarity matrix within the unit interval [0, 1].

The trajectory Shapley value attribution score is calculated with a trained classifier model that determines a probability of a semiconductor wafer being defective. As a result, the illustrative embodiments provide a technical effect of determining whether a semiconductor wafer is defective.

The probability of a semiconductor wafer being defective comprises a binary target variable wherein a value of 1 indicates the presence of a specified defect type and a value of 0 indicates otherwise. As a result, the illustrative embodiments provide a technical effect of expressing the presence of a defect as a binary value.

The trajectory Shapley value attribution score quantifies the contribution of the measurement item to the probability of a semiconductor wafer being defective. As a result, the illustrative embodiments provide a technical effect of attributing responsibility for a defect to a measurement item within a sequence of processes.

The set of sequential process trajectories include trajectories that progress sequentially from a first process without skipping intermediate steps. As a result, the illustrative embodiments provide a technical effect of limiting analysis to uninterrupted sequences of manufacturing processes.

A computer-implemented method performed predictive modeling for an automobile manufacturing procedure. The method comprises defining a lot-sharing count matrix that represents a number of manufacturing operations shared between automobile parts within the same lot up to a point of measurement and defining a similarity matrix with the lot-sharing count matrix. A value function is defined for a set of sequential process trajectories that include a specified measurement item in the sequence, wherein missing variables in the trajectories are imputed by a lot-aware kernel imputation (LAKI) algorithm using a weighted average based on the similarity matrix. Based on the value function, a weighting function is calculated that averages over the set of sequential process trajectories. A trajectory Shapley value attribution score is calculated for the measurement item based on value function and weighting function. The automobile manufacturing procedure is then adjusted according to changes in advanced process control (APC) parameters based on the trajectory Shapley value score. As a result, the illustrative embodiments provide a technical effect of adjusting automotive manufacturing according to a trajectory Shapley value score.

The trajectory Shapley value attribution score is calculated with a trained classifier model that determines a probability of an automobile part being defective, wherein the trajectory Shapley value attribution score quantifies the contribution of the measurement item to the probability of an automobile part being defective. As a result, the illustrative embodiments provide a technical effect of determining whether an automobile part is defective and attributing responsibility for a defect to a measurement item within a sequence of processes.

A computer-implemented method performed predictive modeling for a manufacturing procedure. The method comprises defining a lot-sharing count matrix that represents a number of manufacturing operations shared between parts within the same lot up to a point of measurement and defining a similarity matrix with the lot-sharing count matrix. A value function is defined for a set of sequential process trajectories that include a specified measurement item in the sequence, wherein missing variables in the trajectories are imputed by a lot-aware kernel imputation (LAKI) algorithm using a weighted average based on the similarity matrix. Based on the value function, a weighting function is calculated that averages over the set of sequential process trajectories. A trajectory Shapley value attribution score is calculated for the measurement item based on value function and weighting function. The manufacturing procedure is then adjusted according to changes in advanced process control (APC) parameters based on the trajectory Shapley value score. As a result, the illustrative embodiments provide a technical effect of adjusting manufacturing according to a trajectory Shapley value score.

The trajectory Shapley value attribution score is calculated with a trained classifier model that determines a probability of a part being defective, wherein the trajectory Shapley value attribution score quantifies the contribution of the measurement item to the probability of a part being defective. As a result, the illustrative embodiments provide a technical effect of determining whether a part is defective and attributing responsibility for a defect to a measurement item within a sequence of processes.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

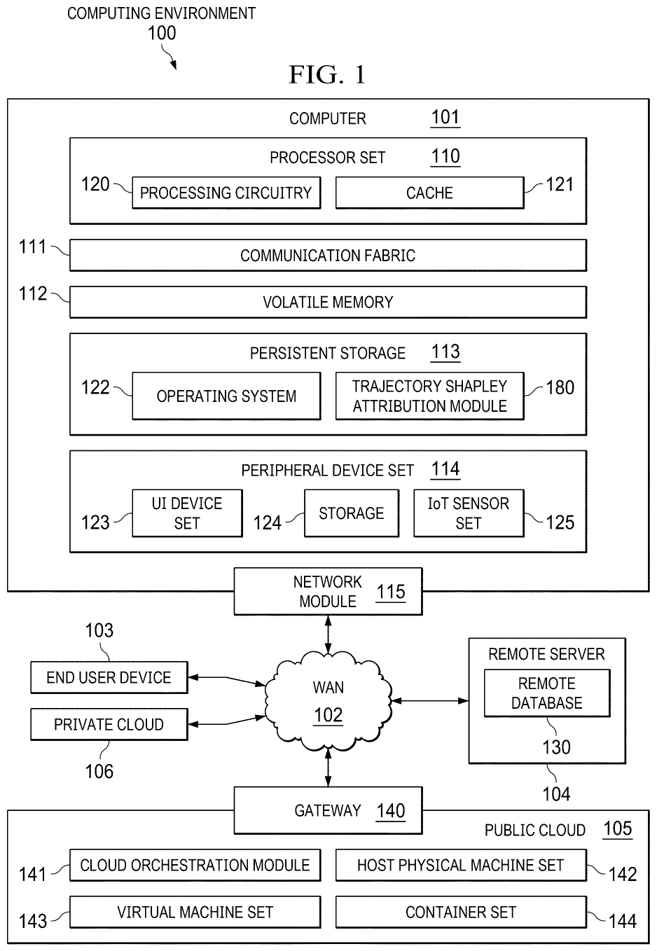

FIG. 1 shows a pictorial representation of a computing environment in which illustrative embodiments may be implemented. Computing environment 100 contains an example of an environment for the execution of at least some of the computer code involved in performing the inventive methods, such Trajectory Shapley Attribution module 180.

In addition to Trajectory Shapley Attribution module 180, computing environment 100 includes, for example, computer 101, wide area network (WAN) 102 end user device (EUD) 103, remote server 104, public cloud 105, and private cloud 106. In this embodiment, computer 101 includes processor set 110 (including processing circuitry 120 and cache 121), communication fabric 111, volatile memory 112 persistent storage 113 (including operating system 122 and Trajectory Shapley Attribution module 180, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142 virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1 On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in Trajectory Shapley Attribution module 180 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in Trajectory Shapley Attribution module 180 typically includes at least some of the computer code involved in performing the inventive methods.

PERIPHERAL DEVICE SET 114 includes the set of peripheral devices of computer 101 Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102 Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101 EUD 103 typically receives helpful and useful data from the operations of computer 101 For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101 Remote server 104 represents the machine(s) that collect and store helpful and useful data for use by other computers, such as computer 101 For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141 The computing resources provided by public cloud 105 are typically implemented by virtual computing environments that run on various computers making up the computers of host physical machine set 142 which is the universe of physical computers in and/or available to public cloud 105. The virtual computing environments (V CEs) typically take the form of virtual machines from virtual machine set 143 and/or containers from container set 144. It is understood that these V CEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to a “as a service” technology paradigm where something is being presented to an internal or external customer in the form of a cloud computing service. As-a-Service offerings typically provide endpoints with which various customers interface. These endpoints are typically based on a set of A Pls. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The illustrative embodiments can be implemented as a Software as a Service model (SaaS) or using an existing infrastructure. The flexibility of deployment allows an organization to utilize the best option for their needs. API connectors can be leveraged to get data from various systems like SIEM (Security Information and Event Management) or EDR (Endpoint Detection and Response). This connection method allows the organization to add as many systems as needed through the API connector.

The illustrative embodiments recognize and take into account that techniques developed in the explainable artificial intelligence (XAI) research community are gaining increasing attention in semiconductor data analytics to address the interpretability challenges of deep-learning-based models and facilitate actionable insights. One key approach is Shapley values (SV), which compute attribution scores for each input variable in a prediction model based on observed input-output pairs. When applied to a VM model, SV can provide valuable insights into which input variables are most responsible for an observed process quality metric. However, for cross-process defect attribution, existing approaches have two main limitations: they fail to respect the sequential nature of manufacturing processes (such as used for semiconductors) and rely on an arbitrarily chosen baseline (or reference) point. These issues stem from the original modeling assumptions of SV.

The illustrative embodiments provide a model-agnostic input attribution algorithm called Trajectory Shapley Attribution (TSA), which is a novel extension of SV designed for scenarios where input variables form a trajectory. In the present context, a trajectory defines a sequential progression of processes such as manufacturing steps. TSA eliminates dependency on an arbitrary baseline point by incorporating a data imputation algorithm that leverages the lot-wafer hierarchy in semiconductor manufacturing. The following explanation applies this methodology to the example of in-line measurements from a state-of-the-art front-end-of-line (FEOL). However, it should be emphasized that the underlying principles of the illustrative embodiments can be applied to other sequential manufacturing processes such as, e.g., automotive manufacturing.

The overall framework of in-line measurement attribution aligns with advanced process control (APC), which encompasses virtual metrology (VM), variable attribution, and recipe tuning as key sub-tasks. APC refers to control techniques for improving performance in industrial processes. APC employs methods such as feedforward, decoupling, and inferential control, as well as advanced algorithms. This type of control can include making adjustments to attributes in a process such as recipe parameters for a specific processing tool in a process. These adjustments can be made in a semi-automated manner. However, most existing studies focus on specific processes. While cross-process dependency analysis and attribution of wafer quality issues are crucial for accelerating yield improvement, the vision of digital twins-namely, data-driven, semi-automated yield control-remains far from reality. In many mass production fabs, yield ramp-up still requires significant manual effort.

The integration of model-agnostic XAI techniques with advanced quality prediction models is a major research trend in semiconductor analytics. This approach aims to strike an optimal balance between predictive power and interpretability. Among various XAI methods, the Shapley value (SV) is the most widely used in semiconductor analytics. Ironically, despite its widespread adoption, most studies treat SV as a black-box software tool, paying little attention to the validity of its modeling assumptions. The original definition of SV may not be fully appropriate for semiconductor manufacturing due to two key issues: 1) variable coalitions include physically inadmissible process routes, and 2) the default baseline value in SHAP (Shapley Additive explanations), a popular Python implementation, disregards the wafer-lot hierarchy. The Trajectory Shapley Attribution (TSA) of the illustrative embodiments addresses these limitations.

Transformer architecture has recently gained attention in semiconductor analytics due to its ability to directly model dependencies between sequential input variables via the self-attention mechanism. However, Transformers are known to be even more data-hungry than RNNs. It remains an open question whether Transformers provide reliable predictive performance in semiconductor applications, given the challenge of extremely low effective sample sizes, as discussed below.

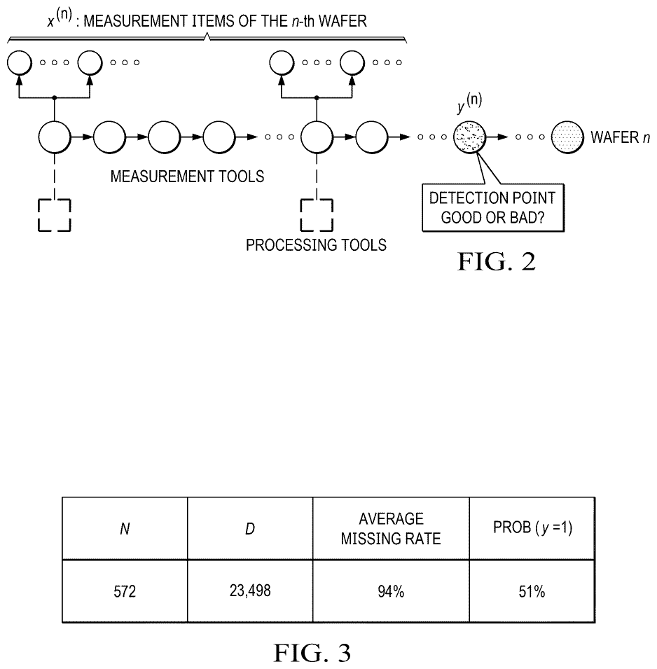

FIG. 2 is a diagram illustrating defect attribution in accordance with an illustrative embodiment. In-line measurement attribution addressed by the illustrative embodiments can be defined as:

Definition 1: Given a binary wafer quality label y∈{0, 1} and a set of in-line measurements x∈ [symbol] (i.e., a D-dimensional real-valued vector), compute the attribution score sᵢ(x) that quantifies the contribution of each measurement item i=1, . . . , D to the outcome y, serving as a proxy for the underlying process.

Here, the binary label is defined as 1 for bad wafers and 0 for good wafers.

As illustrated in FIG. 2 each measurement tool is associated with a specific processing tool and acts as its proxy. Some measurements may be performed multiple times on the same wafer due to reentrant processes. In such cases, only the latest observations are retained, allowing the in-line measurement history to be represented as a fixed-dimensional vector x∈ [symbol] per wafer, although some measurement items may be missing. A single measurement tool can produce multiple measurement items. For example, critical dimensions may be measured at multiple locations on a wafer, with their mean and standard deviation recorded. Consequently, D can be on the order of thousands.

Typically, solving the attribution task requires a predictive model for y as a function of x. Since y is binary, we consider the following classification problem:

Definition 2: Given a training dataset

$$D {=}^{Δ} {\{ ( {x}^{( n )} , {y}^{( n )} ) \}}_{n = 1}^{N} ,$$

train a classifier p(x) that predicts the probability of y=1 (bad) given an input x.

Here, x⁽ⁿ⁾∈ [symbol] denotes the set of observed in-line measurement items for the n-th wafer, and y(n) is its corresponding wafer quality label.

Although the tasks defined above resemble standard attribution and classification problems, semiconductor manufacturing introduces specific challenges that must be considered:
1) Wafers are not necessarily independent due to lot- and batch-based processing.
2) Wafers are processed sequentially, implying an inherent ordering among measurement tools.
3) Most in-line measurement values are unavailable due to wafer-, lot-, and batch-wise sampling policies.

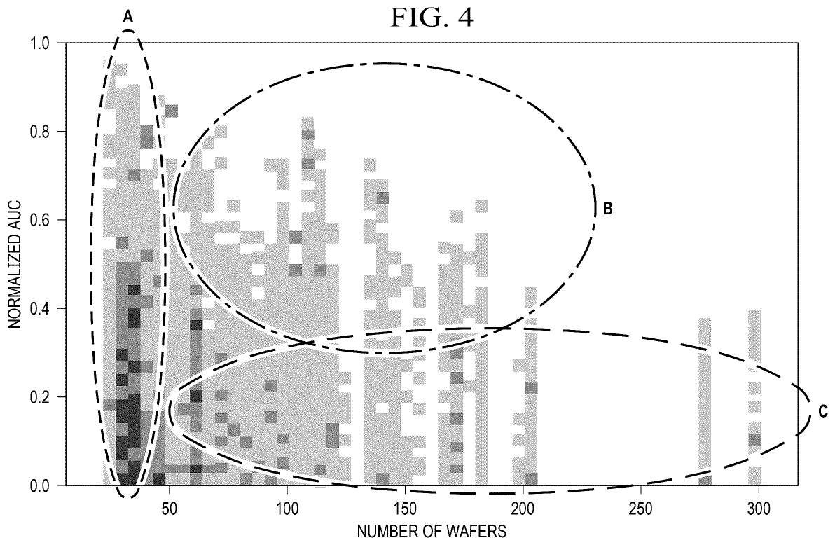

The first and second points render many off-the-shelf machine learning tools ineffective, as most assume sample independence and permutation invariance among variables. Regarding the third point, since wafers are randomly selected for measurement at each tool, the resulting measurement trajectories are nearly unique for each wafer. Furthermore, in the yield ramp-up phase, where various processing recipes are tested simultaneously, the diversity of processing routes is potentially large. This diversity further complicates model training, as the effective sample size, defined as the number of wafers per unique processing or measurement condition, may be extremely small—possibly as low as one. To illustrate the characteristics of a typical wafer dataset, we summarize key statistics from the dataset used in empirical evaluation. As shown in FIG. 3, the dimensionality D far exceeds the number of wafers, making the prediction task ill-posed. The extremely high missing rate exacerbates this challenge.

The goal of SV is to evaluate the influence of each input variable in a prediction. Suppose there are D input variables, denoted as x≙(x1, . . . , xD)^{T}, and a prediction model y=f(x), which corresponds to the probability p(x) in the classification task defined in Definition 2 above. Formally, the SV for the i-th variable is defined as:

$$S {V}_{i} ( {x}^{t} ) = \frac{1}{D} {\sum }_{k = 1}^{D} {\sum }_{S ∈ {S}_{k}^{i}} {( \begin{matrix}D - 1 \\ k - 1\end{matrix} )}^{- 1} [ v ( S ) - v ( S - \{ i \} ) ] \qquad Eq . 1$$

where x^{t} is a test sample at which SV is calculated, and

$${S}_{k}^{( i )}$$

denotes the collection of all index sets of size k (out of the D members) that include i. The notation S−{i} represents the index set obtained by removing i from S.

In the original game-theoretic definition, the term v(S)−v(S−{i}) quantifies the influence of the i-th player within the coalition S, assuming that v(S), known as the value function, represents the outcome achieved by the coalition. Since the number of such possible sets is

$$( \begin{matrix}D - 1 \\ k - 1\end{matrix} ) ,$$

SVᵢ computes the average contribution of the i-th variable across all possible variable combinations. While multiple definitions of v(·) are possible in XAI applications, it is typically chosen as the prediction function itself, as discussed in the next subsection.

A critical question when applying SV in XAI tasks is how to reconcile v(S), which is defined over a subset of variables, with f(x), which requires a full D-dimensional input. To be specific, consider the case where (i, D)=(i, 3) and S={1, 2}. In SHAP's default setting, the value function v(S) evaluated at x=x^{t} is defined as

$$v ( \{ 1 , 2 \} ) = f ( {x}_{1}^{t} , {x}_{2}^{t} , {\overline{x}}_{3} ) ( baseline Shapley ) \qquad Eq . 2$$

where x̅₃ is the population mean of x₃. In this setting, the selected variables in S retain their actual values from x^{t}, while non-selected variables are replaced with default values, which in this case is the population mean. In other application domains, alternative default values are used; for example, in computer vision, pixel values may be set to zero. These variants are collectively referred to as baseline Shapley values.

Another widely used approach marginalizes the non-selected variables using training data:

$$v ( \{ 1 , 2 \} ) = \frac{1}{N} {\sum }_{n = 1}^{N} f ( {x}_{1}^{t} , {x}_{2}^{t} , {x}_{3}^{( n )} ) \qquad Eq . 3$$

which is known as the conditional expectation (CE) Shapley value.

There are two major limitations when applying SV-based attribution using Eq. (1) to semiconductor manufacturing data.

First, while SV provides a theoretically fair method for evaluating variable dependencies, it does not account for the sequential nature of semiconductor processes. In this context, a set S can be viewed as a hypothetical processing route, represented by in-line measurements as proxies. However, many variable combinations are physically inadmissible—for instance, pattern formation without etching. It is unclear whether attribution scores derived from such inadmissible combinations carry meaningful information or should be regarded as artifacts.

Second, SV relies on an arbitrarily chosen baseline point. The use of the population mean as a reference can be problematic, as it disregards the wafer-lot hierarchy. A similar issue arises with CE Shapley, where averaging over training samples does not necessarily preserve the structure of semiconductor processing dependencies.

Beyond these issues, SV is also known to exhibit deviation insensitivity when the prediction function itself is used as the value function. This means that while SV is effective for characterizing the general behavior of f(·), it is not well-suited for explaining deviations of the form f(x^{t})−y^{t}, which is often of primary interest in defect diagnosis tasks.

Given the limitations of standard SVs, the illustrative embodiments provide a novel SV-based framework for measurement attribution. The trajectory Shapley attribution (TSA) framework of the illustrative embodiments comprises two components: lot-aware kernel imputation and trajectory Shapley values.

As discussed above, in-line measurement data contain many missing entries due to lot-, wafer-, and item-specific sampling policies. A key challenge is that missing patterns in in-line measurements are neither purely random nor fully systematic. In the TSA framework, the illustrative embodiments adopt a relatively simple yet effective data imputation approach based on the lot-wafer hierarchy. This imputation method defines the concept of “non-participation” for variables.

Let W_{n,m} denote the kernel function between wafers n and m. To compute W, we first define the lot-sharing count matrix C, where each element C_{n,m} represents the number of operations shared between wafers n and m within the same lot, up to the point where either y(n) or y(m) is measured. C_{n,n} corresponds to the total number of operations that wafer n underwent before the measurement of y(n). Using C, we define the similarity matrix W based on the Jaccard index (which measures similarity and diversity of sample sets):

$${W}_{n , m} {=}^{Δ} \frac{{C}_{n , m}}{{C}_{m , m} + {C}_{n , n} - {C}_{n , m}} , n \neq m \qquad Eq . 4$$

Each element of W lies within the unit interval [0, 1], with diagonal elements W_{n,n} set to zero.

Finally, a LAKI (Lot-Aware Kernal Imputation) algorithm imputes a missing element, denoted as

$${x}_{k}^{( n )} = ⊥ ,$$

using a weighted average based on W:

$${x}_{k}^{( n )} ← \frac{1}{{\sum }_{j} {W}_{n , j}} {\sum }_{m} {W}_{n , m} {x}_{k}^{( m )} \qquad Eq . 5$$

where terms with

$${x}_{k}^{( m )} = ⊥$$

are excluded from the summation. If no peers with observed values for item k exist, we set

$${x}_{k}^{( n )}$$

to x̅ₖ, the mean or item k.

For Trajectory Shapley Values suppose a VM model f(x) that predicts an outcome variable y given a measurement trajectory x. We generalize the standard SV definition in Eq. 1 as follows:

sᵢ(x^{t})=Σ_{S∈T}_{⁽ⁱ⁾}μ(s)[v(S)−v(S−{i})] Eq. 6

where x^{t} denotes an input trajectory of interest, and T⁽ⁱ⁾ is the set of all physically admissible process trajectories that include the i-th measurement item. In semiconductor manufacturing, physically admissible trajectories are those that progress sequentially from the first process without skipping intermediate steps. For example, for (i, D)=(2, 3), the admissible trajectories are (x₁, x₂) and (x₁, x₂, x₃). The prefactor μ(S) is a weighting function that averages over all admissible configurations. To properly determine μ(S), we impose the sum rule on the trajectory Shapley values:

$${\sum }_{i = 1}^{D} {s}_{i} ( {x}^{t} ) = v ( 1 ) - v ( ∅ ) \qquad Eq . 7$$

where v(1) and v(Ø) denote the value function under full variable participation and no participation, respectively. Equations (6) and (7) together define the trajectory Shapley value within our framework.

To define the value function, the index set S and its complement −S are relabeled so that x=(x_{S}, x_{-S}), where the subvector x_{S} collects all xᵢ's for i∈S. The value function in TSA, evaluated at x=x^{t}, is then given by:

v(S)=f(x_{S}=x^{t},x₋ₛ=⊥) Eq. 8

where x_{-S}=⊥ symbolically represents that the nonparticipating variables are treated as missing values. Unlike standard SV, where missing variables are replaced with a fixed baseline value, TSA employs LAKI to adaptively impute ⊥ based on the wafer and lot IDs. Our theoretical analysis has established the following result:

Theorem 1 (Trajectory Shapley Value): The weighting function μ(S) is uniquely determined by Eq. 7. With this μ(S), the trajectory Shapley value is given by:

$${s}_{i} ( {x}^{t} ) = f ( {x}_{1 : i}^{t} , {x}_{( i + 1 ) : D}^{0} ) - f ( {x}_{1 : ( i - 1 )}^{t} , {x}_{i : D}^{0} ) \qquad Eq . 9$$

where x_{s:e} ≙(xₛ, xₛ₊₁, . . . , xₑ) for s≤e, and Ø (the empty set) otherwise.

$${x}_{( i + 1 ) : D}^{0} and {x}_{i : D}^{0}$$

are baseline values computed using the LAKI algorithm.

We applied the Trajectory Shapley Attribution (TSA) approach to a process-limited yield (PLY) root-cause analysis task for state-of-the-art front-end-of-line (FEOL) processing routes. In this empirical evaluation, we focused on a specific scenario involving a burst of a defect type over a certain period. Specifically, we collected data from N=572 wafers, approximately half of which exhibited the defect. A binary target variable y∈{0, 1} was obtained at a PLY measurement point, where y=1 indicates the presence of a specific defect type, and y=0 otherwise. The input variables x comprised upstream in-line measurements from hundreds of measurement processes.

As shown in the table in FIG. 3, the missing value rate is extremely high-only about 6% of the entries contain actual measurements. Additionally, the dimensionality of the input space (D) is much larger than the number of wafers (N), making the prediction task highly ill-posed. In such settings, data-hungry deep learning models are prone to overfitting. Our goal is to identify which measurement items are most relevant to the defect burst by computing attribution scores.

As a baseline approach, we conducted a conventional univariate correlation analysis. Using the training dataset D, we trained a separate univariate logistic regression classifier for each of the D=23,498 measurement items to predict the good-bad wafer flag y. No LAKI imputation was used in this step. Due to missing values, different measurement items had varying sample sizes, which impacted prediction accuracy. For each measurement item, we computed the area under the curve (AUC) score of the receiver operating characteristic (ROC) curve.

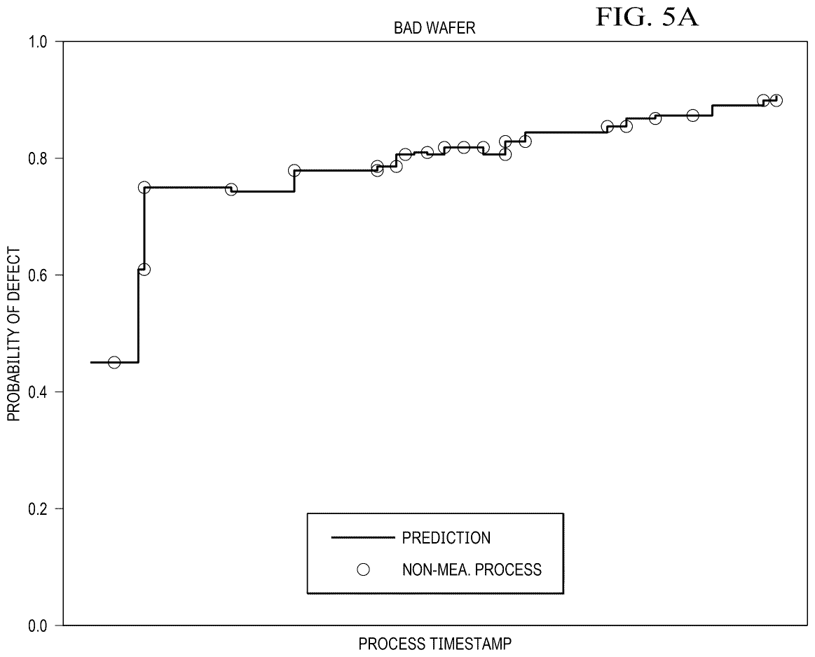

FIG. 4 presents the results of the univariate correlation analysis, where the vertical axis represents the normalized AUC, defined as |2×AUC−1|, which takes a value of 0 for random classification and 1 for perfect classification. As shown, most measurement items produced unreliable results due to insufficient sample sizes (Region A). Generally, measurement items with larger sample sizes exhibited weaker predictive performance (Region C). Although a few items displayed moderate predictive power, no clear dominant predictor emerged (Region B), providing limited actionable insights.

As the first step in the TSA analysis, we trained a binary classifier in the multivariate setting. To mitigate potential overfitting issues, we employed [symbol] 2-regularized logistic regression to model p(x), the probability of observing y=1 (bad wafer). The regularization strength was selected via cross-validation. With LAKI imputation, the true positive rate was 0.80, compared to 0.75 without LAKI, demonstrating the effectiveness of the LAKI strategy.

Using the trained classifier p(x), we computed TSA attribution scores for each wafer outside the training dataset:

$${s}_{i} ( {x}^{t} ) = p ( {x}_{1 : i}^{t} , {x}_{( i + 1 ) : D}^{0} ) - p ( {x}_{1 : ( i - 1 )}^{t} , {x}_{i : D}^{0} ) \qquad Eq . 10$$

Thanks to the sum rule in Eq. 7, we can visualize how “badness” accumulates as a wafer progresses through the processing route.

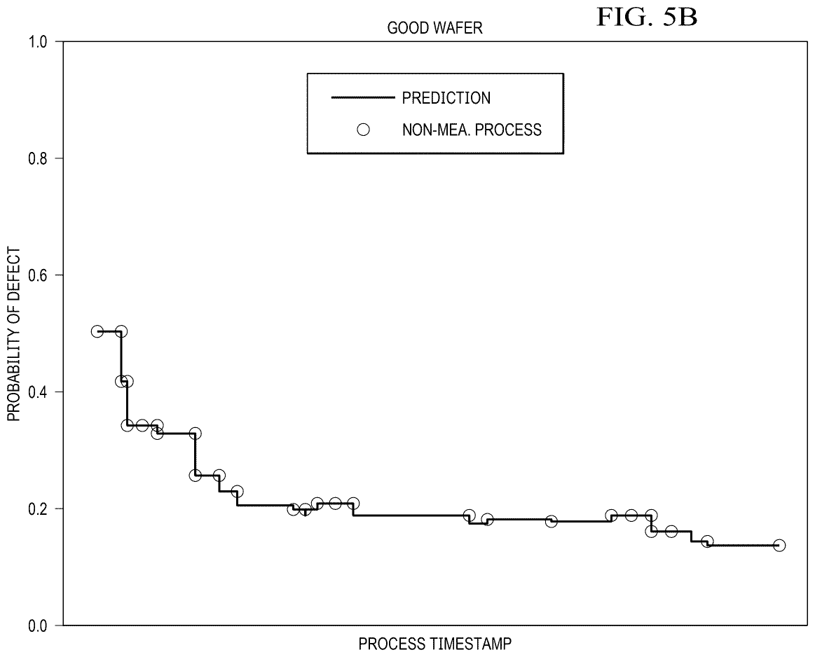

FIGS. 5A and 5B depict graphs illustrating Trajectory Shapley Attribution scoring for bad and semiconductor wafers, respectively. In these graphs, the cumulative sum

$${\sum }_{i = 1}^{k} {s}_{i} + p ( {x}^{0} )$$

is plotted at each timestamp τ, where the latest process index k is defined such that its timestamp tₖ satisfies tₖ≤τ. The cumulative score represents

$$p ( {x}_{\leq τ}^{t} ) , where {x}_{\leq τ}^{t} := ( {x}_{1 : k}^{t} , {x}_{( k + 1 ) : D}^{0} ) .$$

FIGS. 5A and 5B show the progression from the null trajectory outcome p(x⁰) to the full trajectory outcome p(x^{t}) as a function of process timestamps. Notably, certain time points exhibit significant jumps, suggesting potential root causes for favorable or unfavorable outcomes. In particular, FIG. 5A indicates that our TSA approach could have facilitated earlier process termination for defective wafers, potentially months before reaching the PLY measurement point.

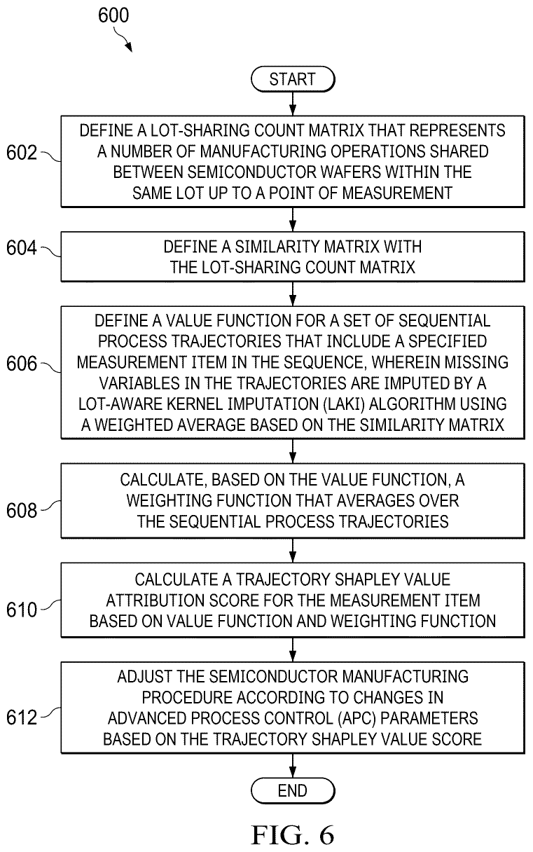

FIG. 6 depicts a flowchart illustrating a method of predictive modeling for a semiconductor manufacturing procedure in accordance with an illustrative embodiment. Process 600 can be carried out by Trajectory Shapley Attribution module 180 in FIG. 1

Process 600 begins by defining a lot-sharing count matrix that represents a number of manufacturing operations shared between semiconductor wafers within the same lot up to a point of measurement (step 602) and then defining a similarity matrix with the lot-sharing count matrix (step 604). The similarity matrix may be based on the Jaccard index. Each element of the similarity matrix lies within the unit interval [0, 1].

Process 600 defines a value function for a set of sequential process trajectories that include a specified measurement item in the sequence, wherein missing variables in the trajectories are imputed by a lot-aware kernel imputation (LAKI) algorithm using a weighted average based on the similarity matrix (step 606). The set of sequential process trajectories include trajectories that progress sequentially from a first process without skipping intermediate steps. Using the value function, process 600 calculates a weighting function that averages over the set of sequential process trajectories (step 608).

Process 600 then calculates a trajectory Shapley value attribution score for the measurement item based on value function and weighting function (step 610). The trajectory Shapley value attribution score may be calculated with a trained classifier model that determines a probability of a semiconductor wafer being defective. The probability of a semiconductor wafer being defective comprises a binary target variable wherein a value of 1 indicates the presence of a specified defect type and a value of 0 indicates otherwise. The trajectory Shapley value attribution score quantifies the contribution of the measurement item to the probability of a semiconductor wafer being defective.

The semiconductor manufacturing procedure is adjusted according to changes in advanced process control (APC) parameters based on the trajectory Shapley value score (step 612). Process 600 then ends.

The method of process 600 can be generalized to other sequential manufacturing processes such as automobile manufacturing as well as general manufacturing, wherein the lot-sharing count matrix that represents manufacturing operations shared between parts (automobile or other types of parts) within the same lot instead of semiconductor wafers. Similarly, the trajectory Shapley value attribution score would be calculated with a trained classifier model that determines a probability of a part being defective.

As used herein, “a number of” when used with reference to items, means one or more items. For example, “a number of parameters” is one or more parameters. As another example, “a number of operations” is one or more operations.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combination of these items can be present. In some illustrative examples, “at least one of” can be, for example, without limitation, two of item A; one of item B; and ten of item C; four of item B and seven of item C; or other suitable combinations.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration but are not intended to be exhaustive or limited to the embodiments disclosed. Not all embodiments will include all of the features described in the illustrative examples. Further, different illustrative embodiments may provide different features as compared to other illustrative embodiments. M any modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A computer-implemented method of predictive modeling for a semiconductor manufacturing procedure, the method comprising:
defining a lot-sharing count matrix that represents a number of manufacturing operations shared between semiconductor wafers within the same lot up to a point of measurement;
defining a similarity matrix with the lot-sharing count matrix;
defining a value function for a set of sequential process trajectories that include a specified measurement item in the sequence, wherein missing variables in the trajectories are imputed by a lot-aware kernel imputation (LAKI) algorithm using a weighted average based on the similarity matrix;
calculating, based on the value function, a weighting function that averages over the set of sequential process trajectories;
calculating a trajectory Shapley value attribution score for the measurement item based on value function and weighting function; and
adjusting the semiconductor manufacturing procedure according to changes in advanced process control (APC) parameters based on the trajectory Shapley value score.

2. The method of claim 1, wherein the similarity matrix is based on the Jaccard index.

3. The method of claim 1, wherein each element of the similarity matrix lies within the unit interval [0, 1].

4. The method of claim 1, wherein the trajectory Shapley value attribution score is calculated with a trained classifier model that determines a probability of a semiconductor wafer being defective.

5. The method of claim 4, wherein the probability of a semiconductor wafer being defective comprises a binary target variable wherein a value of 1 indicates the presence of a specified defect type and a value of 0 indicates otherwise.

6. The method of claim 4, wherein the trajectory Shapley value attribution score quantifies the contribution of the measurement item to the probability of a semiconductor wafer being defective.

7. The method of claim 1, wherein the set of sequential process trajectories include trajectories that progress sequentially from a first process without skipping intermediate steps.

8. A system for predictive modeling for a semiconductor manufacturing procedure, the system comprising:
a storage device that stores program instructions;
one or more processors operably connected to the storage device and configured to execute the program instructions to cause the system to:
define a lot-sharing count matrix that represents a number of manufacturing operations shared between semiconductor wafers within the same lot up to a point of measurement;
define a similarity matrix with the lot-sharing count matrix;
define a value function for a set of sequential process trajectories that include a specified measurement item in the sequence, wherein missing variables in the trajectories are imputed by a lot-aware kernel imputation (LAKI) algorithm using a weighted average based on the similarity matrix;
calculate, based on the value function, a weighting function that averages over the set of sequential process trajectories;
calculate a trajectory Shapley value attribution score for the measurement item based on value function and weighting function; and
adjust the semiconductor manufacturing procedure according to changes in advanced process control (APC) parameters based on the trajectory Shapley value score.

9. The system of claim 8, wherein the similarity matrix is based on the Jaccard index.

10. The system of claim 8, wherein each element of the similarity matrix lies within the unit interval [0, 1].

11. The system of claim 8, wherein the trajectory Shapley value attribution score is calculated with a trained classifier model that determines a probability of a semiconductor wafer being defective.

12. The system of claim 11, wherein the probability of a semiconductor wafer being defective comprises a binary target variable wherein a value of 1 indicates the presence of a specified defect type and a value of 0 indicates otherwise.

13. The system of claim 11, wherein the trajectory Shapley value attribution score quantifies the contribution of the measurement item to the probability of a semiconductor wafer being defective.

14. The system of claim 8, wherein the set of sequential process trajectories include trajectories that progress sequentially from a first process without skipping intermediate steps.

15. A computer program product for predictive modeling for a semiconductor manufacturing procedure, the computer program product comprising:
a persistent storage medium having program instructions configured to cause one or more processors to:
define a lot-sharing count matrix that represents a number of manufacturing operations shared between semiconductor wafers within the same lot up to a point of measurement;
define a similarity matrix with the lot-sharing count matrix;
define a value function for a set of sequential process trajectories that include a specified measurement item in the sequence, wherein missing variables in the trajectories are imputed by a lot-aware kernel imputation (LAKI) algorithm using a weighted average based on the similarity matrix;
calculate, based on the value function, a weighting function that averages over the set of sequential process trajectories;
calculate a trajectory Shapley value attribution score for the measurement item based on value function and weighting function; and
adjust the semiconductor manufacturing procedure according to changes in advanced process control (APC) parameters based on the trajectory Shapley value score.

16. The computer program product of claim 15, wherein the similarity matrix is based on the Jaccard index.

17. The computer program product of claim 15, wherein each element of the similarity matrix lies within the unit interval [0, 1].

18. The computer program product of claim 15, wherein the trajectory Shapley value attribution score is calculated with a trained classifier model that determines a probability of a semiconductor wafer being defective.

19. The computer program product of claim 18, wherein the probability of a semiconductor wafer being defective comprises a binary target variable wherein a value of 1 indicates the presence of a specified defect type and a value of 0 indicates otherwise.

20. The computer program product of claim 18, wherein the trajectory Shapley value attribution score quantifies the contribution of the measurement item to the probability of a semiconductor wafer being defective.

21. The computer program product of claim 15, wherein the set of sequential process trajectories include trajectories that progress sequentially from a first process without skipping intermediate steps.

22. A computer-implemented method of predictive modeling for an automobile manufacturing procedure, the method comprising:
defining a lot-sharing count matrix that represents a number of manufacturing operations shared between automobile parts within the same lot up to a point of measurement;
defining a similarity matrix with the lot-sharing count matrix;
defining a value function for a set of sequential process trajectories that include a specified measurement item in the sequence, wherein missing variables in the trajectories are imputed by a lot-aware kernel imputation (LAKI) algorithm using a weighted average based on the similarity matrix;
calculating, based on the value function, a weighting function that averages over the set of sequential process trajectories;
calculating a trajectory Shapley value attribution score for the measurement item based on value function and weighting function; and
adjusting the automobile manufacturing procedure according to changes in process control parameters based on the trajectory Shapley value score.

23. The method of claim 22, wherein the trajectory Shapley value attribution score would be calculated with a trained classifier model that determines a probability of an automobile part being defective, and wherein the trajectory Shapley value attribution score quantifies the contribution of the measurement item to the probability of an automobile part being defective.

24. A computer-implemented method of predictive modeling for manufacturing procedure, the method comprising:
defining a lot-sharing count matrix that represents a number of manufacturing operations shared between parts within the same lot up to a point of measurement;
defining a similarity matrix with the lot-sharing count matrix;
defining a value function for a set of sequential process trajectories that include a specified measurement item in the sequence, wherein missing variables in the trajectories are imputed by a lot-aware kernel imputation (LAKI) algorithm using a weighted average based on the similarity matrix;
calculating, based on the value function, a weighting function that averages over the set of sequential process trajectories;
calculating a trajectory Shapley value attribution score for the measurement item based on value function and weighting function; and
adjusting the manufacturing procedure according to changes in process parameters based on the trajectory Shapley value score.

25. The method of claim 24, wherein the trajectory Shapley value attribution score would be calculated with a trained classifier model that determines a probability of a part being defective, and wherein the trajectory Shapley value attribution score quantifies the contribution of the measurement item to the probability of a part being defective.
